(19) United States
(12) Patent Application Publication
(10) Pub. No.: US 2002/0038286 A1
(43) Pub. Date: Mar. 28, 2002

(54) System and method for secure e-commerce

(76) Inventors: Lea Koren, Haifa (IL); Nachum Koren, Haifa (IL)

Correspondence Address: ROSENMAN & COLIN LLP, 575 MADISON AVENUE, NEW YORK, NY, 10022-2585, US

(21) Appl. No.: 09/942,273

(22) Filed: Aug. 29, 2001

(30) Foreign Application Priority Data
Sep. 5, 2000 (IL) 138273

(51) Int. Cl. G06F 17/60

(52) U.S. Cl. 705/40; 705/39; 235/379

(57) ABSTRACT

A system and method for allowing a user of a distributed network to perform a secure payment transaction initiated over a network, such as the Internet, by using a financial data card, such as a credit card, the system comprising at least one vendor site connected to the network, at least one user computerized system comprising a computer connected to the network and a safe payment unit connected to the user's computer, the safe payment unit including a data card reader, an authentication protocol for verifying the authenticity of a data card received through the card reader, a storage means for storing transaction information and a means for telephone communication with a remote computer system; an online computerized system of a trusted agent accessible to said safe payment unit by a telephone communication means.

### BACKGROUND OF THE INVENTION

1. Field of the Invention

The present invention relates to electronic commerce in general and to a system and method for performing secure and anonymous remote purchasing of merchandise and services over the Internet, in particular.

2. Discussion of the Related Art

Electronic commerce, in particular between private customers and sellers, (the so-called B2C commerce, business to customers) has not been progressing as rapidly as had been expected.

One reason for the relatively slow development of e-commerce is the payment arrangements over the network, which require transmitting sensitive information (such as credit card number and personal information) via an unsecured network and the fear of misuse of that information by unauthorized users. Another reason is the difficulty to establish mutual trust between two remote parties, who are completely unknown to each other, when both sides have no means to confirm the information revealed by the other. Sellers cannot be sure the deal will not be denied later by the customer and that their payment will be paid, customers cannot be sure that goods will be provided or that the seller will not misuse the information revealed to him.

Thus, potential customers, as well as potential sellers, are reluctant over joining e-commerce. It is well known that potential customers, surfing through the internet, spend a considerable amount of time at vendors' web sites, doing quite a thorough market research, even reaching a decision, but withdraw at the last moment when they have to enter their personal and credit card details. Potential vendors, on their side, do not join e-commerce too eagerly either since, aside from the aforementioned reasons, as long as customers are reluctant about e-commerce, the expected profits are limited, making the investment in e-commerce unworthy.

Coming to overcome these problems, psychological aspects as well as technological aspects should be taken into account. A good solution should provide not only a suitable technology but also improvement of security feeling and the relief of psychological inhibitions.

The main approach taken in the art in order to provide secure transactions over the Internet is by encrypting the sensitive information transmitted, using various encoding-decoding protocols. However, as long as the information is transmitted over the Internet, even if it is in the most sophisticated cryptographic form, fear always exists that it might be captured and decoded by unauthorized users. Furthermore, while vendors can verify the credit information given to them by customers, either by using conventional verification methods or by special methods implanted for e-commerce, there is still no satisfactory answer for the reservations a customer has about giving personal information to a practically unknown (and probably overseas) seller.

There is therefore a need for a better system and method that will allow Internet users to conduct secure commercial transactions, and in particular, which will allow a user-buyer to perform a secure and anonymous purchasing of merchandise without transmitting sensitive information over the data network. SUMMARY OF THE PRESENT INVENTION

It is therefore an object of the present invention to provide a system and method that will overcome the aforementioned drawbacks for enhancing e-commerce.

It is another object of the present invention to provide a system which will allow a customer to perform secure and anonymous purchasing of merchandise and services initiated over a non-secure distributed public network.

It is yet another object of the present invention to provide such a system, which is user-friendly and simple to operate.

Still it is another object to provide such a system, which resembles “traditional” purchasing and is based on operations well known to a user-buyer.

It is further an object of the present invention to provide a system and method that take full consideration of both sides of the electronic transaction and are not biased to any.

In accordance with the above and other objects, the present invention provides a novel system and method which provides a solution to the aforementioned drawbacks.

The system of the present invention allows a user of a distributed network, such as the Internet, to perform a secure payment transaction initiated over said network, by using a financial data card. The system of the present invention also allows the user to remain anonymous to the payee of said transaction.

The system comprises vendor sites connected to said network; users computerized systems connected to said network and an online computerized system of a trusted agent accessible by telephone communication, wherein said computerized system includes a database of users accounts and of qualified vendors. Said trusted agent is preferably a credit cards issuer company or a mediator agent mediating between credit card users and credit card issuer companies.

Each of said users computerized systems includes a computer connected to the network and a novel safe payment unit connected to said computer, wherein said safe payment unit includes a data card reader, an authentication protocol for verifying the authenticity of a data card received through said card reader, a storage means for storing transaction information and a means for telephone communication with the remote computerized system of the trusted agent, and wherein said computer includes a software application for allowing a communication with said safe payment unit. According to a preferred embodiment of the present invention the safe payment further comprises a keypad and indicator lights for indicating the mode of the unit, a display and a printer or means to connect to an external printer. Preferably the safe payment unit also includes encrypting means for encrypting the information transmitted to the trusted agent.

Each of said vendor sites is running a set of electronic commerce-related software applications including a software application for allowing a user to perform payment transaction via a safe payment unit and each of said users computers is running a software application for accessing and browsing the vendor sites.

The present invention further relates to a method for allowing a user to perform secure and anonymous transactions initiated over a distributed network in the system described above. The method comprises the following steps: a) sending over the network an order request from a user computer to a vendor site, said request specifying payment via a safe payment unit; b) in response to said order request from user computer, generating in vendor site a transaction message and sending said message over the network to said user computer, said transaction message including transaction data; c) downloading said transaction message from user computer to said safe payment unit connected to said user computer; d) inserting a data card to a card reader of said safe payment unit for reading data of said data card; e) performing an authentication procedure to verify authenticity of said data card; f) if card authentic, transmitting card data and said transaction data to the trusted agent to verify the transaction, preferably said data card and transaction data is encrypted before being sent.

The authentication procedure may include a comparison between the card identifier code read by the card reader to card identifier codes stored in safe payment unit memory and between a password code entered by the user and a password code stored in safe payment unit memory, wherein said password code can be associated with the data card or with the safe payment unit.

According to a preferred embodiment of the present invention, the method further comprises the steps of receiving in the safe payment unit a transaction verification signal from the trusted agent and confirming the payment by sending a payment confirmation signal to the trusted agent wherein said confirmation signal may include an electronic signature of the customer. Upon sending said payment confirmation signal, the method can further comprise the steps of printing a transaction receipt, sending a message to the user computer and sending a signal over the network from the user computer to the vendor site indicating the transaction completion.

The method of the present invention further comprises a step of sending a notice of transaction from the trusted agent to the vendor, said notice of transaction includes the transaction data assigned by the vendor with additional transaction data assigned by the trusted agent but does not include the customer's credit card and personal information data.

### BRIEF DESCRIPTION OF THE DRAWINGS

The present invention will be understood and appreciated more fully from the following detailed description of preferred embodiments taken in conjunction with the drawings in which:

FIG. 1 is an overall schematic illustration of the system of the present invention;

FIG. 2 is a schematic illustration of the system in accordance with a preferred embodiment of the present invention;

FIG. 3 is a schematic illustration of the unit for safe payment (PSU) of FIG. 1 in accordance with a preferred embodiment of the present invention;

FIG. 4 is a flow diagram of the steps of the overall procedure at the customer, vendor and Credit Company site in accordance with an embodiment of the present invention;

FIG. 5 is a flow diagram of the steps performed at the customer site;

FIG. 6 is a flow diagram of the steps performed at the vendor site;

FIG. 7 is a flow diagram of the steps performed by the Pay-Safe Unit PSU;

FIG. 8 is a flow diagram of the steps performed at the credit company site.

### DETAILED DESCRIPTION OF THE PREFERRED EMBODIMENTS

The present invention overcomes the disadvantages of the prior art by providing a novel method and system, which enable a secure and anonymous payment for merchandise and services via a public network.

The present invention involves customers, vendors and a trusted agent, wherein said customers and vendors are registered clients of said credit company and in particular are registered clients of the system of the present invention.

The approach taken by the present invention is a novel approach. It provides, in addition to the net communication channel between customer and buyer, an additional off-the-net channel for the transfer of sensitive data between the customer and a trusted agent which is the financial institution which has the authority for certifying said transaction. Said agent is preferably a credit card issuer financial institution (such as Visa, American Express, Diners etc.), hereinafter referred to as Credit Company (CC). The separate channel is established by means of a novel payment unit for safe payment, hereinafter referred to as Pay-Safe-Unit or PSU. The PSU communicates with the user's computer and independently communicates with the trusted authorizing agent. Said PSU is a portable unit that can be connected to any computer and any phone lines anywhere. The information transmitted between said PSU and the credit company server might be cryptographically encrypted for adding security.

The present invention provides high obligation and security to the buyer as well as to the seller. The buyer does not have to reveal personal information, neither through the Internet, nor to the seller, while the seller gains high guarantee that the deal will not be denied. Once an agreement was settled, neither side can deny it.

The present invention will be described in detail in conjunction with the preferred embodiments depicted in the drawings. However, it will be understood that these embodiments are not intended to limit the invention, and that alternatives, modifications and equivalents may be included within the spirit and scope of the invention as defined by the claims.

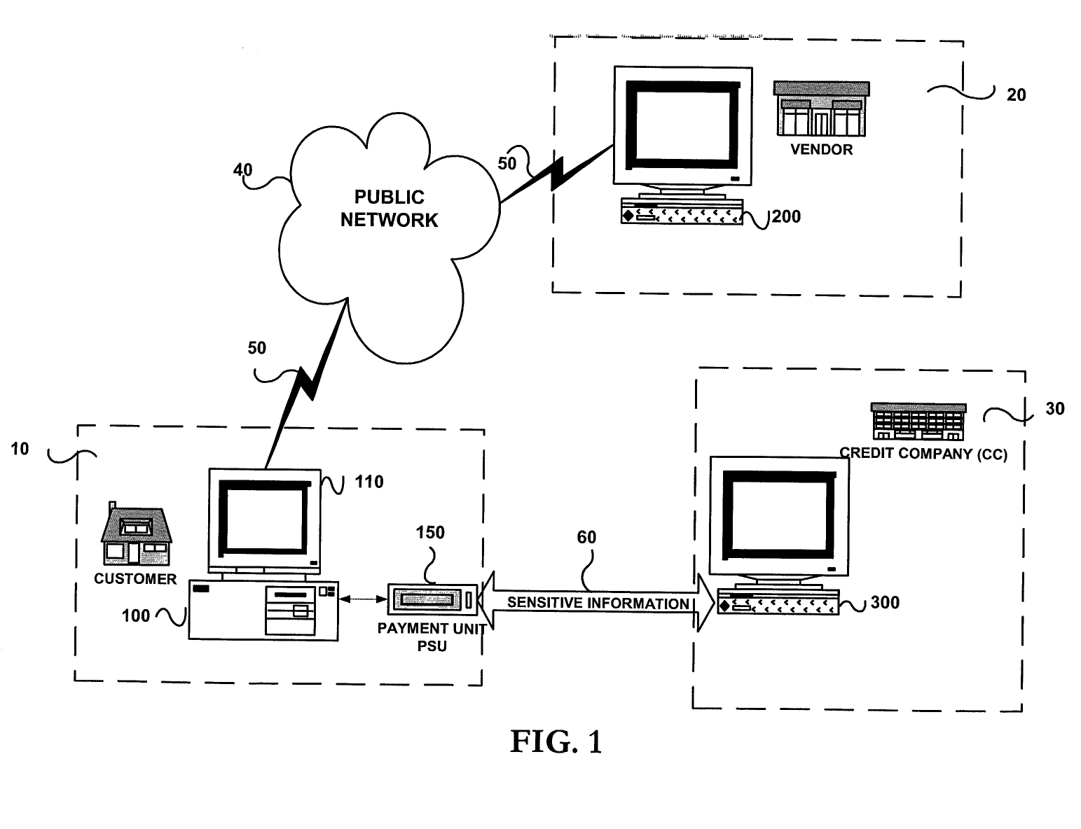

Reference is now made to FIG. 1, which is a schematic illustration of the system of present invention and the environment in which the system is operating. The system includes a customer computerized system 10, a vendor computerized system 20 and a credit company (CC) computerized system 30. The system further includes two communication channels, a communication channel 50 over the distributed data network 40 for interactive communication between customer and vendor and an off-the-net channel 60 for online communication between customer and credit company. It should be realized that although the illustration presents only one customer and one vendor, it represents many net-users that can function as customers, as vendors or as both.

Customer computerized system 10 includes a novel safe payment unit (PSU) 150 connected to customer computer 100 and having means, such as a modem, for connection to a phone line. Upon initiating, PSU establishes a connection to online credit company computer system 30 over a conventional telephone line, thus opening communication channel 60, for transferring sensitive data only between the customer and the credit company. In order to add security, said sensitive data may be transferred over the phone lines in an encrypted form.

Computer 100 includes a display terminal 110 for graphically displaying user interface, a means for connection to a public network 40, such as a modem, and an installed application program for supporting access to network sites, network browsing and data transfer to and from remote network sites. Also installed on computer 100 is a novel software application for allowing performance of the method according to the present invention. Said novel software application accepts data from vendor's site and controls the data transfer from computer 100 to PSU 150. Computer 100 is preferably a PC but can be of any other data processing device with means for connecting to the Internet, such as a workstation, a mini computer, an interactive television linked to internet via cables or satellite, a cellular phone and the like.

Vendor computerized system 20 consists of a computer 200 with a set of electronic commerce-related software applications which enable a user 10 to connect to vendor's web site, to browse an electronic catalogue displaying vendor's items list, and to initiate acquiring of goods and services by filling in an order form. Such software applications are developed and distributed by several software companies such as Oracle, Inc. Said order form typically includes a payment options menu. Embedded in said e-commerce-related software is a novel software application specific to the present invention, which allows a specific payment option according to the present invention. The novel software application could be developed using standard Internet-related development tools such as HTML, Java, VBScript and the like.

It should be realized that in the context of the present invention the term “vendor” is used to describe any entity that requires a person to provide financial credit card type of information in order to carry out a transaction with said entity. Besides suppliers of goods and services, a vendor according to the present invention can be for example a supplier of services over the internet, such as an information supplier, or a nonprofit organization asking for donations. The system of the present invention can be utilized also for paying periodical bills such as telephone bills, electricity bills, municipal bills, etc.

The credit company computerized system 30 comprises a computer server 300 and a database (not shown) containing qualified vendors accounts data and customers accounts data.

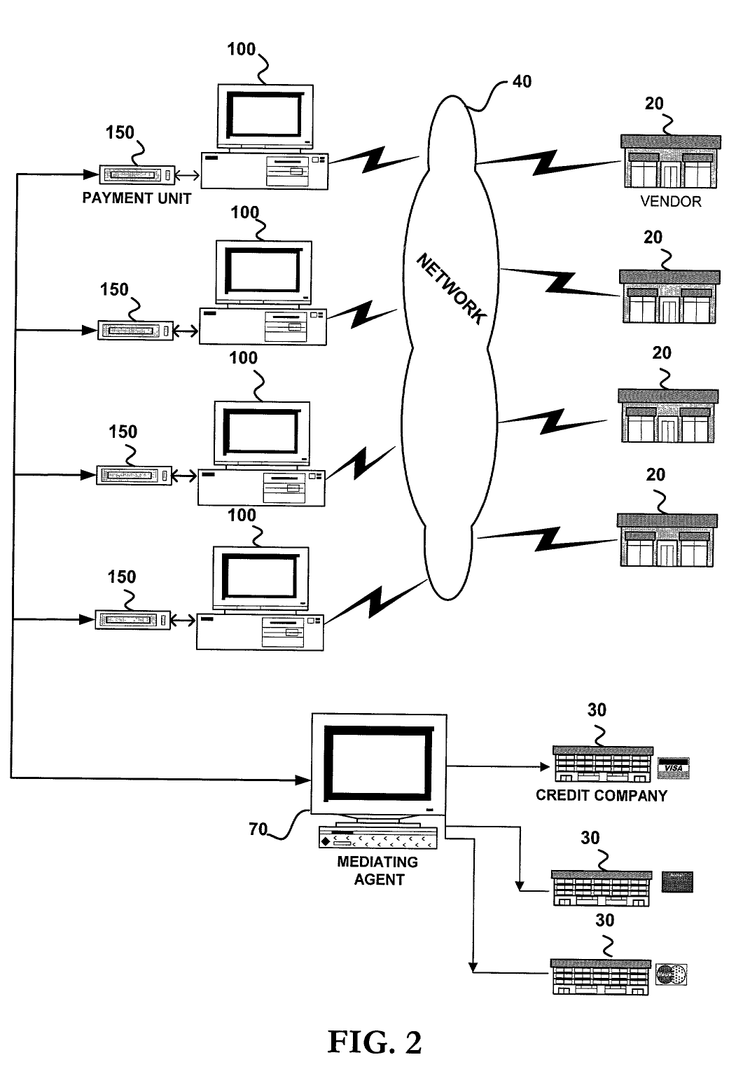

Reference is now made to FIG. 2, which illustrates a system according to another embodiment of the present invention. Customers computers 100 are connected to vendors 20 via data network 40. According to this embodiment there is a mediator agent 70 between private customers 10 and credit companies 30, which receives, sorts and organizes orders from individual safe payment units 150 and directs the data flow to the credit company sites 30 and from credit company back to customers. Said server can be operated by the credit company 30 itself or by another “mediating” agent company, (also known in the art as acquirer). It can serve a specific credit company or a number of credit companies, in which case, said mediator server 70 also serves to sort between different credit companies (according to card identification) and to direct orders to respective companies, then redirect the responses (verification signal plus CC transaction number, or denial signal) to respective customer's PSU 150.

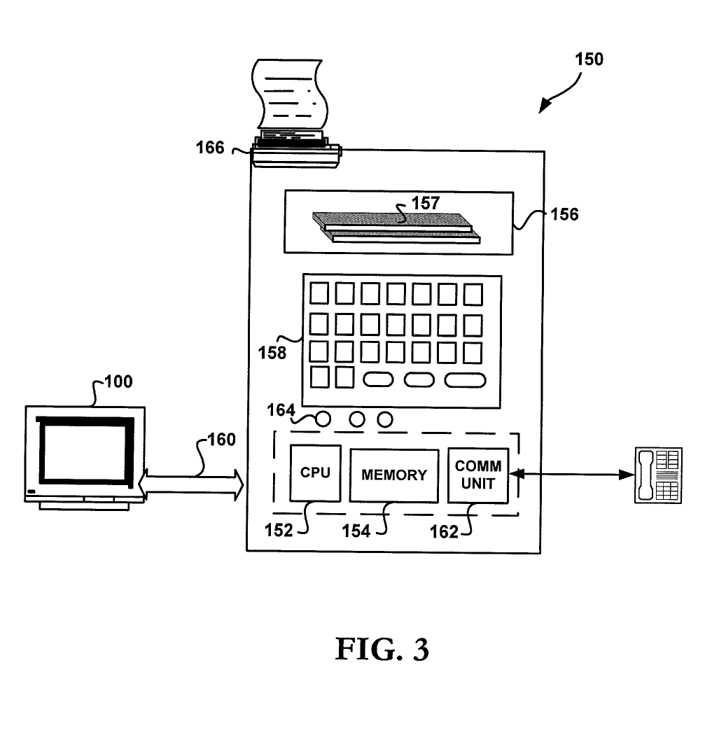

Reference is now made to FIG. 3 which is a schematic illustration of the safe payment unit (PSU) 150 in accordance with a preferred embodiment of the present invention.

The payment unit 150 comprises a CPU 152; a storage device 154; a card reader 156; a keypad 158 containing keys for entering digits, functions key such as ENTER, CLEAR etc., and optionally keys for entering alphabetic symbols; a connector 160 to computer 100, said connector could be a serial connector, such as an RS232-C connector, or a parallel connector; a communication unit 162, such as modem coupled to a phone line; and indicator lights 164 for indicating operational mode of the unit (standby waiting mode, receiving information mode, transmitting information mode, etc.). Preferably, the unit includes a printer 166or means to connect to an external printer. The unit may further include a display (not shown) for displaying instructions and messages to the user.

The card reader has a card slot 157 configured to receive a data card, and a reading head (not shown) adjacent to said slot 157 for reading the data stored on said data card, when said card is swiped through (or inserted into) slot 157. Said data card and reading head can be of any type known in the art providing they are compatible. For example, the data card can be a magnetic strip card such as a typical credit card, an optic card or a smart card wherein the reading head is a magnetic reader, or an optical reader or a smart card reader respectively.

According to a preferred embodiment, said payment unit is an independent portable unit that can be connected to any computer and any phone line.

The PSU of the present invention can be a unit similar to the T7P terminals supplied by Universal payment processing or to Switch_series 700 terminals supplied by SWITCH communication Ltd., slightly modified and programmed in accordance with the present invention

Yet according to further another embodiment, said unit can be an integral part of a cellular phone.

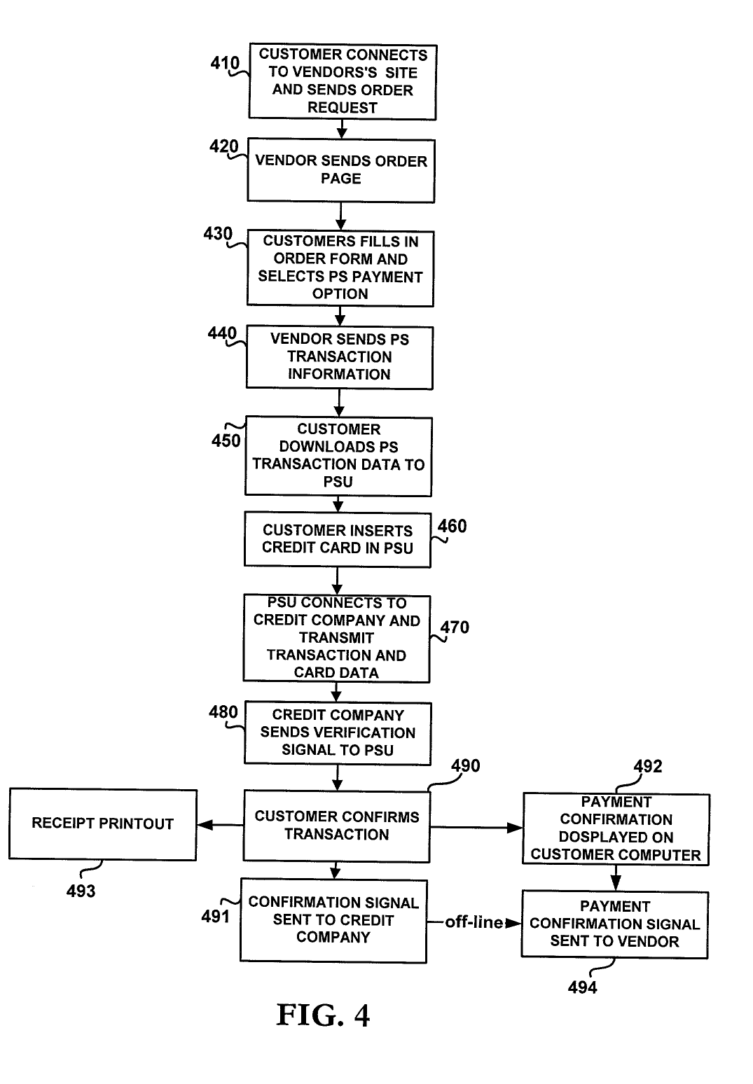

Reference is now made to FIG. 4, which is a flow diagram representing the steps of the method for secure electronic transactions in accordance with an embodiment of the present invention, in terms of the overall general steps taken in the customer site, the vendor site and the credit company (or credit company mediator agent) site.

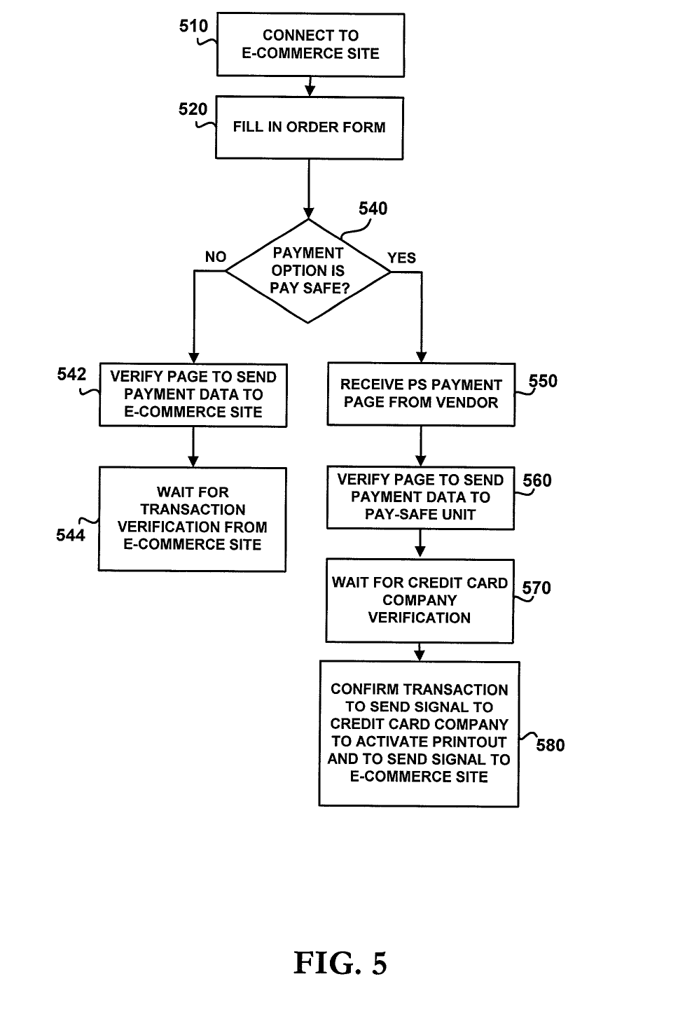

In step 410, a customer connects to a seller's web site and choosing to purchase items from the seller's catalogue, the customer enters an order request which is sent over the network to the vendor computer. In response, the vendor sends an order form (step 420) to be filled by the customer. According to the present invention, said order page includes, in the payment options menu, the option of paying by safe payment unit (PSU), hereinafter referred to as PS option. An additional detail as to the manner of connecting to the seller's web site is provided in conjunction with FIG. 5 and the accompanying description.

Selection of the PSU payment option by the customer (430) initiates the Pay-Safe PS software program in the customer site and in the vendor site respectively, wherein the vendor PS software and the customer PS software are compatible with each other, allowing communication and data transfer between vendor and customer computer platforms according to predetermined protocols.

If customer selects other payment option offered by the vendor, the order is processed in the standard e-commerce manner in accordance with the specific selected option.

Upon receipt of PS selection along with other details of the order (items identifiers, quantities etc.), the order is processed by the PS software at the vendor site and a detailed PS transaction message (step 440) is sent to and displayed in the customer computer.

In step 450, the customer transmits the transaction data to the PSU. When the data download is complete and the data is stored in the PSU memory, the customer inserts or swipes his credit card to or through the PSU slot 157 (step 460) and enters a code or a number of codes for authentication, said code or codes can be the password (secret code) associated with said card and/or a code associated with the PSU, such that only upon entering the PSU code, the unit is activated. The authentication protocol can include other identification means such as a fingerprint identification.

If authentication protocol passed successfully, the PSU connects to the online server of the Credit Company (or CC agent and transfers the data to be processed by said server (470). Following processing by the CC computerized system, either a verification signal or a denial signal is sent back to the PSU (480) together with the assigned credit company transaction identifier (480). Said CC transaction identifier preferably includes credit company (or CC agent) identifier.

If a verification signal received, and if the customer decides to proceed with order, he confirms the payment transaction (step 490) by performing a confirmation act, such as pressing a button programmed to this purpose on the PSU. Optionally the confirmation act further includes entering a second code and/or an electronic signature of the customer.

The customer confirmation act finalizes the transaction and activates three simultaneous actions: a confirmation signal is sent to the credit company (491); a confirmation signal is sent to and displayed on the customer computer (492); a detailed receipt is printed by printer 166 (step 493). From the customer computer a confirmation signal is transferred to the vendor's site (494) via the network along with the credit company transaction identifier.

Off-line, a notice of the transaction is processed at the credit company (or agent) site and is sent to the vendor via conventional mail or e-mail (493). The notice includes the vendor transaction and order identifiers, the credit company transaction identifier and may include other data such as transaction date and time, amount of payment, etc. Said notice need not include any personal data of the customer, in particular it does not include customer's credit card data.

Reference is now made to FIGS. 5, which is a flow diagram of the steps performed by the software installed on customer computer. In steps 510 customer connects to vendor's e-commerce site and fills in an order form (step 520) including the payment option (540). If other than PS option is chosen (542), the customer fills in all necessary data needed in order to complete the transaction, including his personal and credit card data and sends the form to the vendor. The verification procedure is handled at the vendor's site and the customer waits for receiving a transaction verification notice from the vendor (544).

If the customer selects the PSU option, the credit card information is not filled in. Furthermore, if the customer is not interested giving his home address, a post office box address may be given instead. The filled order page with a PS indicator is sent to the vendor and in response, a PS transaction message is received from the vendor (550) in a form suitable to be downloaded into customer's PSU. Said transaction message can be in a format ready to be downloaded into the customer's PSU as it is, or can be processed by the software installed on the customer computer for generating a transaction message in a form suitable to be downloaded into said PSU. If the customer chooses to proceed with the order, the transaction message is transmitted to the PSU (560). In accordance with a preferred embodiment of the present invention, downloading the data into the PSU unit by the customer, causes a signal to be sent to the vendor, indicating the willingness of the customer to proceed with that particular transaction. This additional signal facilitates the transactions processing at the vendor site. If said signal, indicating downloading data into PSU at the customer site, is not received at the vendor site, said particular transaction can be neglected by vendor, saving unnecessary further processing.

When the transfer of data to the PSU is complete, and upon successful authentication, the data is transferred from the PSU to the credit company site, and the system waits for a verification or a refusal signal while the transaction is being processed at the credit company site (570).

Upon final customer payment confirmation (580), a confirmation signal is sent to the Credit Company, and a confirmation mark is displayed in the customer computer, indicating the completion of the transaction. Optionally, a payment confirmation signal along with the credit card transaction number is sent to the vendor over the public net.

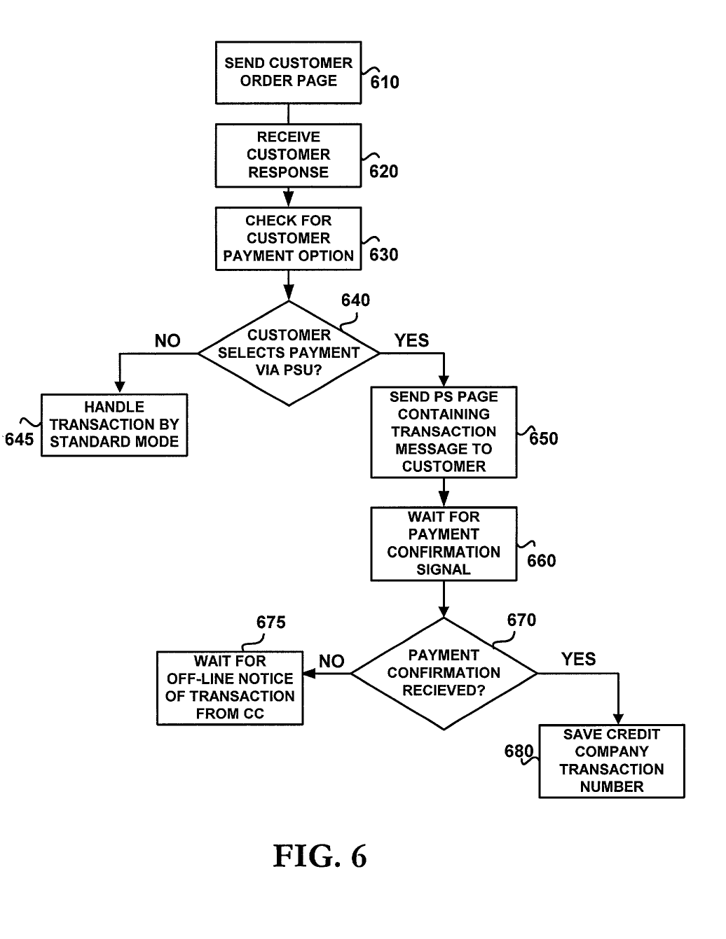

Reference is now made to FIG. 6, which is a flow diagram of the steps performed at the vendor site. Upon receiving a request from a customer, the vendor sends an order form electronic page to be filled by the customer (610). Said order page includes in the payment options menu, the option of PS payment. When the filled page is received from the customer (620), the program checks whether the PS option was selected (630, 640). If other than PS option was selected, the transaction is handled by the standard e-commerce method according to the selected option (645).

If the PS option was selected, the PS special software is initiated and takes over the order handling. A detailed PS transaction message is sent to the customer (650) in a format suitable to be processes by the PS software installed on the customer computer. The message includes the vendor's identifier code (which can include country and area code); the vendor's transaction identifier (which can be a combination of letters and digits which identify items, order, seller, buyer etc.); an order identifier (assigned by the seller); the sum to be paid and the payment conditions. The form displayed on the customer computer may include more information than is actually transmitted to the payment unit. Such additional information can be for example a detailed list of the ordered items, supply conditions etc.

Following the transmission of the detailed transaction message to the customer, the vendor waits for receiving a payment confirmation signal from the customer (660). If a confirmation signal is received (670), it is optionally accompanied with the credit card transaction code, which is saved along with all the other details of that transaction (680). The payment confirmation signal received from the customer confirmed the payment and the vendor can proceed with processing the order, i.e., handling the delivery of merchandise to the customer. Yet, according to another embodiment of the present invention, the vendor does not proceed with the order until he receives a the notice of transaction from the Credit Company (675).

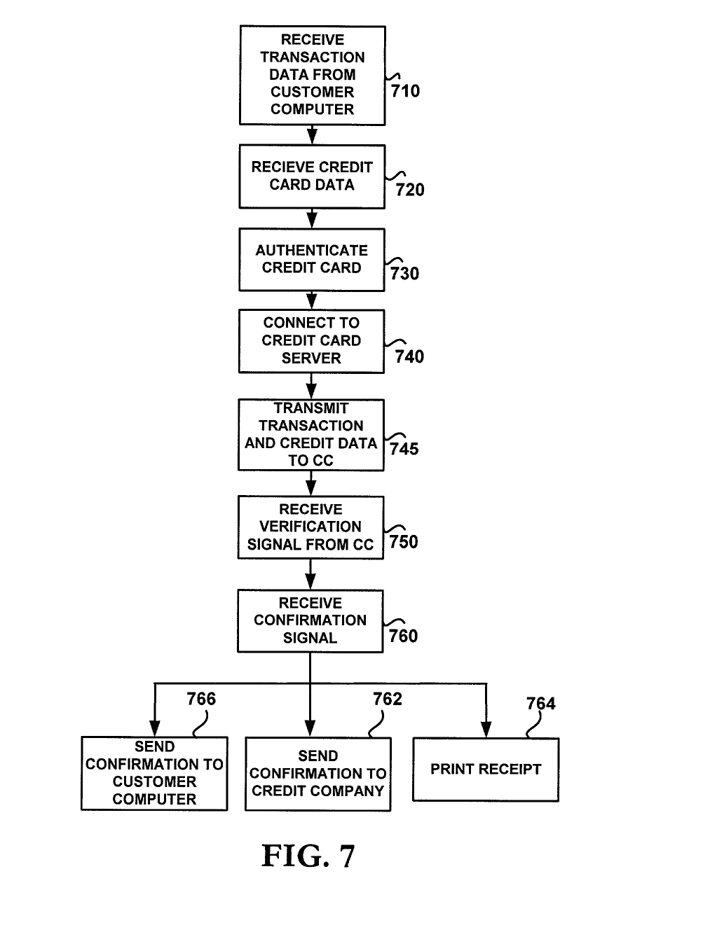

Reference is now made to FIG. 7, which is a flow diagram of the steps performed at the pay-safe unit. In step 710 the transaction data is received from the customer computer and stored in PSU memory. The customer is prompted, either from the computer or from the PSU to insert or pass his credit card to or through the card reader and to enter his code (720). Next the PSU performs an authentication check (730) and if card found to be authentic, the unit connects to the online credit company (or CC agent) server and transfer the data to be verified by the credit company (740). Said data includes, in addition to the order details transmitted from vendor, the credit card data of the customer (745).

In accordance with a special embodiment of the present invention there could be further security precautions for ensuring authentic use of the PSU unit. According to this embodiment, a PSU is dedicated to a specific card or a number of specific cards (for example, the cards held by a family members), such that only if the card reader identifies said specific card or cards, an authentication is confirmed and the procedure continues. If no match is found, the PSU fails to proceed and no transaction is performed.

When a verification signal and a credit company transaction number are received in the PSU (750), the customer is prompted to confirm the transaction. Optionally the detailed order is printed out at this stage in order to enable the customer to view all transaction details before final confirmation. Upon final confirmation (760), a confirmation signal is sent by PSU to the credit company (762), a receipt is printed out (764) by printer 166 and a confirmation signal is sent along with the CC transaction number to the customer computer (766). It should be emphasized that while the printed receipt includes the credit card details, the information concerning the credit card is not transferred to the customer computer, thus all communication concerning sensitive information is limited to the communication channel connecting the PSU with the credit company.

In accordance with another embodiment of the present invention, more than one transaction can be stored in the PSU before connecting to the CC server. This embodiment allows a user to perform a number of transactions with different vendors while connected to the data network, download the transactions data to be saved in the PSU and sending the data for verification at his convenient time.

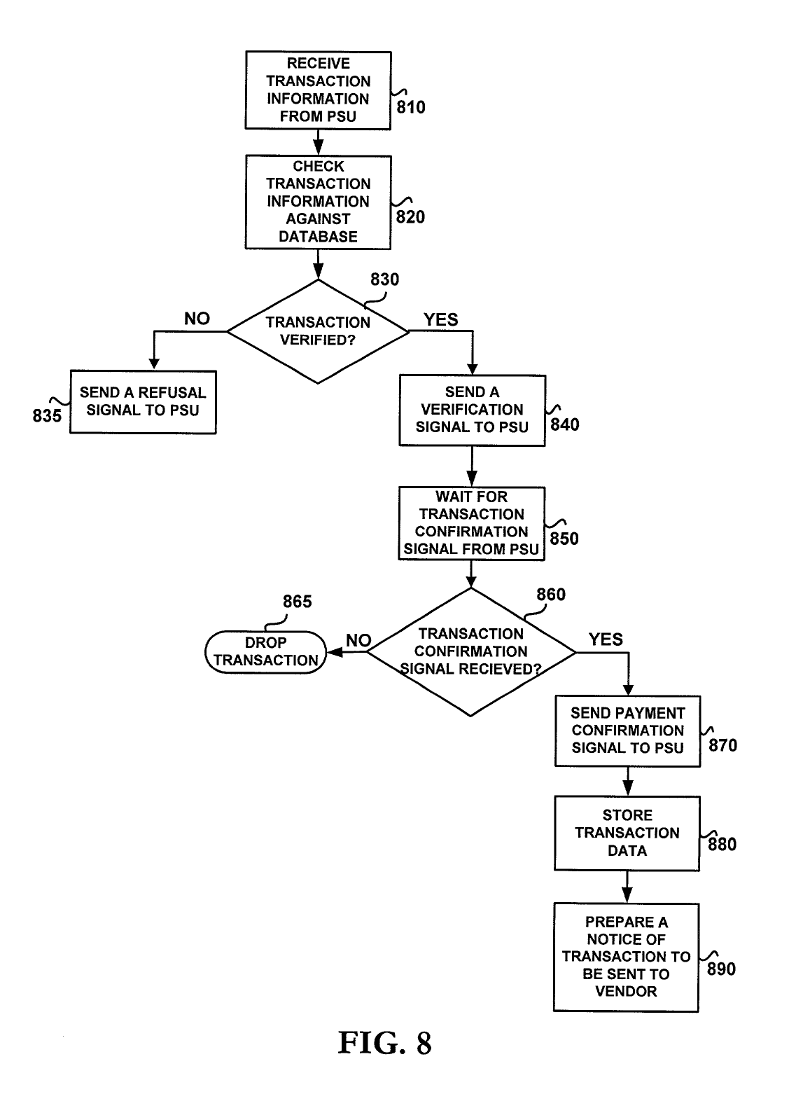

The operation of the CC (or CC agent) computer system is schematically illustrated in FIG. 8. Upon receipt of a transaction query from a PSU (810), the system runs a checking procedure against a database containing customers and qualified vendors data (820, 830). If the vendor does not appear in the qualified vendors list or if the customer credit for the particular transaction is denied (because the amount exceeds the card limit, or because the credit card is canceled or expired), a refusal signal is sent to the PSU (835). If transaction is permitted, the system assigns a CC transaction code to the transaction and a verification signal is sent back to the PSU (840). After sending a verification signal, the system waits (850) for the final customer transaction confirmation for a predetermined period of time (860). If during said period of time no response is received from customer, this particular transaction is dropped (865). If a confirmation signal is received during said period, the system proceeds with the payment processing, a payment confirmation signal is sent to the PSU (870), the transaction data is stored (880) and a notice of transaction (which does not include customer credit card data and personal details) is prepared to be sent to vendor off-line (890). Further processing of the transaction, for charging the customer's credit account and crediting the vendor's account, is continued off line according to the conventional procedure used by the credit company in conventional transactions. According to a preferred embodiment, all the transaction notices performed between users and a specific vendor are collected by the trusted agent and are sent together to said specific vendor periodically, preferably at the end of each business day.

The system of the present invention offers a potential e-customer a highly secured method for purchasing merchandise and services via a non-secure distributed public network. The customer does not need to expose credit card data and personal information over the network. Furthermore, said data is not revealed even to the vendor. The method of the present invention takes full consideration of both sides of the electronic transaction and provides high obligation, security and guarantee to the e-seller as well as to the buyer. Once a transaction was completed according to the system and procedure of the present invention, neither party can deny it.

In addition to the above advantages, the present system also offers the advantage of providing a method for performing transactions of the so called “a card present transaction” as opposed to “a non-card present transaction”. Card preset transactions, being of a lesser risk, involve lower commission fees, thus reduce vendor expenses and consequently might reduce customer expenses as well.

It will be appreciated by persons skilled in the art that with minor modifications of the above described system and method, the present invention can be utilized for a numerous transactions, not necessarily of a commercial or financial nature, which are initiating over an unsecured data network and in which the user is required to give personal data (i.e., to be identified) in order to proceed and perform the transactions. The PSU of the present invention allows for an authentication and authorization procedure by an online agent which is the authority for certifying said transactions, through a separate and secure channel.

Thus, receiving a certification (permission) signal from said authorizing agent enables the user to proceed with the transaction, while the sensitive information is kept off the unsecured data network.

It will be appreciated by persons skilled in the art that the present invention is not limited to what has been particularly shown and described hereinabove. Rather the scope of the present invention is defined only by the claims, which follow.

1. A system for allowing a user of a distributed network to perform a secure payment transaction initiated over said network by using a financial data card, the system comprising:
at least one vendor site connected to said network;
at least one user computerized system comprising a computer connected to said network and a safe payment unit connected to said user computer, said safe payment unit including a data card reader, an authentication protocol for verifying the authenticity of a data card received through said card reader, a storage means for storing transaction information and a means for telephone communication with a remote computer system;
an online computerized system of a trusted agent accessible to said safe payment unit by a telephone communication means;

2. The system of claim 1 wherein the distributed network is the Internet.

3. The system of claim 1 wherein said user remains anonymous to the payee.

4. The system of claim 1 wherein the vendor site is running a set of electronic commerce-related software applications.

5. A system according to claim 4 wherein the said set of electronic commerce-related software applications includes a software application for allowing a user to perform payment transaction via said safe payment unit.

6. The system of claim 1 wherein the user computer is running a software application for accessing and browsing vendor sites.

7. The system of claim 1 wherein the user computer includes a software application for allowing a communication with said safe payment unit.

8. The system of claim 1 wherein said trusted agent is a credit card issuer company and wherein said data card is a credit card issued by said company.

9. The system of claim 1 wherein said trusted agent is a mediator agent mediating between credit card users and credit cards issuer companies.

10. The system of claim 1 wherein said computerized system of trusted agent includes a database of users accounts.

11. A system according to claim 10 wherein said database further includes data of qualified vendors.

12. The system of claim 1 wherein said safe payment further comprising a keypad and indicator lights for indicating unit mode.

13. A system according to claim 12 wherein said safe payment unit further comprises a display.

14. A system according to claim 12 wherein said safe payment unit further comprises a printer or means to connect to an external printer.

15. A system according to claim 12 wherein said safe payment device further comprising encrypting means for encrypting the information transmitted to said online computerized system of trusted agent.

16. A method for allowing a user to perform secure and anonymous transactions initiated over a distributed network in a system comprising a plurality of vendors sites accessible to users computers through said network and wherein said user computer is connected to a safe payment unit, said method comprising the following steps:
sending over said network an order request from a user computer to a vendor site, said request specifying payment via a safe payment unit;
in response to said order request from user computer, generating in vendor site a transaction message and sending said message over the network to said user computer, said transaction message including transaction data;
downloading said transaction message from user computer to said safe payment unit connected to said user computer;
inserting a data card to a card reader of said safe payment unit for reading data of said data card;
performing an authentication procedure to verify authenticity of said data card;
if card authentic, transmitting card data and said transaction data to a trusted agent to verify transaction.

17. The method of claim 16 wherein said distributed network comprising the Internet.

18. The method of claim 16 wherein said user remains anonymous to vendor.

19. The method of claim 16 wherein said trusted agent is a credit card issuer company and wherein said data card is a credit card issued by said company.

20. The method of claim 16 wherein said trusted agent is a mediator agent mediating between credit card users and a credit card issuer companies.

21. The method of claim 16 wherein the authentication procedure includes a comparison between said data card identifier code read by said card reader and card identifier codes stored in safe payment unit memory.

22. A method according to claim 21 wherein said authentication protocol further includes a comparison between a password code entered by the user following the insertion of said user's data card and a password code stored in safe payment unit memory, said password code can be associated with said data card or with said safe payment unit.

23. The method of claim 16 wherein said transaction data includes a transaction identifier code assigned by the vendor, a vendor information, the amount of payment and items information.

24. The method of claim 16 further comprising a step of encrypting the said card data and said transaction data before transmitting for a verification to said trusted agent.

25. The method of claim 16 further comprising the following steps:
receiving in the safe payment unit a transaction verification signal from said trusted agent;
confirming the payment by sending a payment confirmation signal to the trusted agent.

26. The method of claim 25 wherein said confirmation signal includes an electronic signature of the customer.

27. A method according to claim 25 wherein upon sending said payment confirmation signal, a transaction receipt is printed by the safe payment unit and a message is sent to the user computer indicating the transaction completion.

28. A method according to claim 25 further comprising a step of sending a signal from the user computer to the vendor site indicating the transaction completion, said signal is sent over the data network.

29. The method of claim 25 further comprising a step of sending a notice of transaction from the trusted agent to the vendor, said notice is sent via a conventional mail or an e-mail and includes the transaction data assigned by the vendor with additional transaction data assigned by the trusted agent but does not include the customer's credit card and personal information data.

30. A method according to claim 29 wherein said notice of transaction is part of a collection of transactions notices sent periodically, preferably at the end of each business day, by the trusted agent to a vendor, said collection includes all users transactions performed with said vendor during the period of time that elapsed from the last time such a collection was sent to said vendor.
